(19) United States
(12) Patent Application Publication
(10) Pub. No.: US 2003/0065451 A1
(43) Pub. Date: Apr. 3, 2003

(54) Method and system for microorganism identification by mass spectrometry-based proteome database searching

(76) Inventors: Fernando J. Pineda, Baltimore, MD (US); Jeffrey S. Lin, Silver Springs, MD (US)

Correspondence Address: Francis A Cooch Office of Patent Counsel, Applied Physics Laboratory, The John Hopkins University, 11100 Johns Hopkins Road, Laurel, MD, 20723-6099, US

(21) Appl. No.: 10/204,720

(22) PCT Filed: Apr. 11, 2001
(86) PCT No.: PCT/US01/11649

(51) Int. Cl. G06F 19/00

(52) U.S. Cl. 702/19

(57) ABSTRACT

A simple statistical model that predicts the distribution of false matches between peaks in matrix-assisted laser desorption/ionization mass spectrometry data and proteins in proteome databases is derived and validated. Given the cluttered and incomplete nature of the data, it is likely that neither simple ranking, nor simple hypothesis testing will be sufficient for truly robust microorganism identification over a large number of candidate microorganisms. In an effort to increase robust microorganism identification, the proteome databases are restricted to include data related to a given set of proteins, and not all proteins. By removing data from the proteome databases, the model is made more robust, i.e., there is a decrease in the number of false matches.

### BACKGROUND OF THE INVENTION

1. Field of the Invention

The present invention relates to microorganism identification. More specifically, the present invention relates to a method and system for identifying microorganisms by mass spectrometry-based proteome database searching.

2. Description of the Related Art

Proteins expressed in microorganisms can be used as biomarkers for microorganism identification. In particular, mass spectra obtained by matrix-assisted laser desorbtion/ionization (MALDI) time-of-flight (TOF) instruments have been employed for rapid microorganism differentiation and classification. The identification is based on differences in the observed “fingerprint” protein profiles for different organisms, typically in the mass range 4-20 kDa. A crucial requirement for successful identification via fingerprint techniques is spectral reproducibility. However, mass spectra of complex protein mixtures depend in an intricate and oftentimes poorly characterized fashion on a number of factors including sample preparation and ionization technique (e.g., MALDI matrixes, laser fluence), bacterial culture growth times and media, etc.

It has been proposed to exploit the wealth of information contained in prokaryotic genome and proteome databases to create a potentially more robust approach for mass spectrometry-based microorganisms identification (See Demirev, P. A.; Ho, Y. P.; Ryzhov, V.; Fenselau, C., Anal. Chem 1999, 71, 2732-8). This approach is independent of the chosen ionization and mass analysis model. The central idea of this proposed approach is to match the peaks, in the spectrum of an unknown microorganism, with the annotated proteins of known microorganisms in a proteomic database (e.g., the internet-accessible SWISS-PROT proteomic database).

The plausibility of the proposed approach was demonstrated by identifying two microorganisms whose genomes are known (B. subtilis and E. coli). The identification was performed by assigning a matching score, k, to each microorganism. This score was simply the number of spectral peaks that matched (to within a specified mass tolerance) the annotated proteins of each of the microorganisms in the database. The microorganisms were subsequently ranked according to their score, and the microorganism with the highest score was declared to be the unknown source of the spectrum.

Although this simple ranking algorithm succeeded in correctly identifying two microorganisms from a relatively small database, it was nonetheless understood from the onset that more rigorous methods would be necessary to perform robust identification of a broader range of microorganisms over more comprehensive databases. A key component of robust microorganism identification must be the ability to quantitatively assess the risk of false identification. In the present setting, false identification can occur when a large number of spectral peaks accidentally match the masses of proteins in the proteome of an unrelated microorganism. The likelihood of accidental matches, and hence the likelihood of false identification, increases, if the mass tolerance is increased or if the size of the known proteome increases.

In general, it is impractical to estimate the risk of false identification by exhaustively performing a large number of proteome-spectrum comparisons with a large number of experimentally obtained spectra. Instead, it is necessary to base quantitative methods on models of the matching and measurement processes.

Accordingly, a need exists to develop, validate and apply an algorithmic model of the matching and measurement processes and use it to estimate the likelihood of misidentification and to gain insight into the nature of the microorganism identification problem. A need also exists to decrease the number of false matches by restricting the number of known proteins in the proteomic database.

### SUMMARY OF THE INVENTION

The present invention provides a system and method of quantifying the significance of microorganism identification by mass spectrometry-based proteome database searching through the use of a statistical model of false matches. The key to the false match model is the simplifying assumption that the proteins in a microorganism's proteome are uniformly distributed in the mass range of interest. This allows one to calculate the expected number of matches between the peaks in a mass spectrum and the peaks in a proteome. Thus, one can immediately test the null hypothesis that the mass spectrum was not generated by the microorganism in question.

Specifically, the present invention provides a system for determining a probability of observing false matches between spectral peaks of an unknown source and spectral peaks of known microorganisms. The system includes a proteomic database for storing data of known microorganisms; a processing module for determining the spectral peaks of known microorganisms using the proteomic database; and a scoring algorithm for comparing the spectral peaks of the unknown source with the spectral peaks as determined by the processing module for the known microorganisms. The scoring algorithm derives a score for the unknown source based on the number of spectral peaks of the unknown source that match spectral peaks of known microorganisms. The system further includes a probability module using at least the derived score and proteomes corresponding to the known microorganisms to determine the probability of observing false matches between the spectral peaks of the unknown source and the spectral peaks of the known microorganisms.

### BRIEF DESCRIPTION OF THE DRAWINGS

FIG. 1 is a block diagram of a system for identifying an unknown source having a proteome database, a processing module and a scoring algorithm according to the present invention;

FIG. 2 is a chart illustrating a probability density function (p.d.f.) of protein masses for bacterial proteins in the SWISS-PROT proteome database;

FIG. 3 is a chart illustrating a fraction of incorrectly matched peaks as a function of proteome size for Δm={1, 3, 10, 30} Da according to the present invention; and

FIGS. 4A and 4B are charts illustrating a standard error in the fraction of incorrectly matched peaks as a function of proteome size for Δm={30, 3} Da, respectively, using the present invention.

### DESCRIPTION OF THE PREFERRED EMBODIMENTS

To assess the likelihood of false identification, the present invention derives a model-based distribution of scores due to false matches. For a given known microorganism with a corresponding annotated proteome, the inventive model denotes this distribution as P_{K} (k), where K is the number of peaks in the spectrum of the unknown and k is the number of these peaks that match proteins in the proteome. The distribution derived is based on the approximation that the proteins in the underlying proteome are uniformly distributed. This approximation amounts to characterizing the true distribution of proteins by its first moment. To test this approximation, the derived distribution P_{K} (k) is compared to histograms obtained from simulated experiments which are performed by sampling simulated spectra from the true protein distributions contained in the proteome database.

The distribution P_{K} (k) allows testing of the significance of the scores via hypothesis testing and allows for quantifying the scalability of the approach by establishing limits on the size of the database (number of individual proteomes) and on the size of the proteomes in the database. Finally, the null hypothesis, H₀, is tested that the unknown and the known microorganisms are not the same.

I. Theory

I.a. The setting

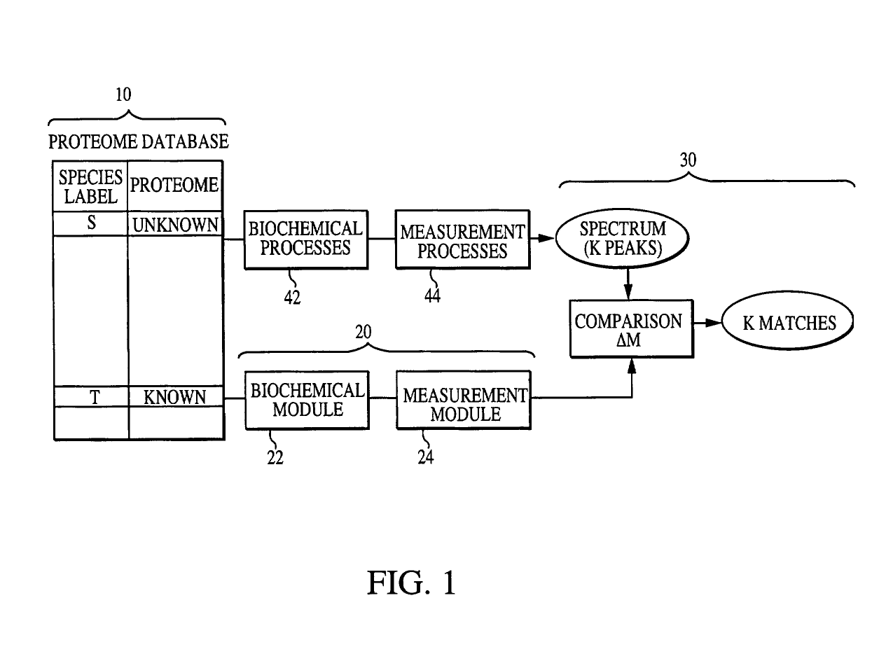

This section derives and justifies an approximate probability distribution for observing exactly k false matches when a spectrum from an unknown microorganism is compared to the proteome of a known microorganism according to the invention. In the mass range [mₘᵢₙ, mₘₐₓ], the spectrum is assumed to have K peaks and the proteome is assumed to have n proteins. For the purposes of statistical analysis it is useful to work within an unambiguous problem setting. A preferred system setting according to the present invention is illustrated in FIG. 1 and contains three primary components: 1) a database 10, 2) a processing module 20; and 3) a scoring algorithm 30.

The database 10 contains a label and the corresponding proteome for each potentially observable microorganism. It is understood that the proteomes in the database 10 are neither necessarily complete, nor error free. Proteomes may be incomplete because the microorganism in question has not been fully sequenced, or because the proteome has been pruned of low abundance proteins to reduce the likelihood of false matches. Proteomes may have errors due to genetic variability, i.e., strain differences and because the process of annotation is itself an imperfect process. Nevertheless, the inventive system and method assumes that each proteome is sufficiently inclusive and sufficiently accurate, that it is reasonable to expect that some of the proteins in the proteomes will be found in a physical mass spectrum. In such a setting it is reasonable to compare a spectrum to a proteome.

The processing module 20 includes a biochemical module 22 and a measurement module 24. The proteome of a microorganism is not directly observable. Instead, proteomes are inferred from measurements. For purposes of the present invention, a measurement is a random process that starts with the proteome and generates an observable spectrum through a set of stochastic transformations that account for complex biochemical and measurement, i.e., physical, processes. Examples of biochemical processes 42 are posttranslational modification and RNA edits. Examples of measurement processes 44 are multiple charge states, adduct ion formation, prompt and metastable ion fragmentation.

Noise processes that create spurious peaks also contribute to the complexity of the measurement process. To obtain a tractable preliminary analysis it is useful to neglect all these complexities and to model the measurement process as a simple random draw (without replacement) of the proteins in the source proteome. The mass of each randomly draw protein is referred to as a “peak” and the set of masses is referred to as a “spectrum”.

The scoring algorithm 30 is simple and known by one ordinarily skilled in the art. For example, the scoring algorithm is used in Demirev et al. The spectrum from an unknown source is compared to a known proteome by matching spectral peaks against proteins in proteomes. A database hit occurs when the mass of a protein in the database 10 differs from the mass of a spectral peak by at most Δm/2. A spectral peak with one or more database hits is said to be a “matched peak”. The number of spectral peaks that match proteins in a microorganism's proteome is said to be the “score” of the microorganism.

I.b. Theoretical Distribution of False Matches

To derive the approximate distribution of false matches, assume that the unknown source (s) and the known microorganism (t) are distinct (i.e., s≠t). Then, by definition, all matches are false matches. We make the simplifying assumption that the proteins in the proteomes are uniformly distributed throughout the mass range [mₘᵢₙ, mₘₐₓ]. The only free parameter in a uniform distribution is the density of proteins (i.e., the number of proteins per unit mass interval). Under this assumption, it is straightforward to write down P_{match}, which is the probability that a given peak will be a matched peak. In particular, given any interval of width Δm about a mass m, the probability P(q) of obtaining exactly q database hits is Poisson distributed:

$$P ( q ) = \frac{{( ρΔ m )}^{q} {ⅇ}^{- ρΔ m}}{q !} , \qquad ( 1 )$$

where ρ=n/(mₘₐₓ−mₘᵢₙ) is the density of proteins in the proteome in the mass range [mₘᵢₙ, mₘₐₓ]. Consequently, the probability of obtaining no database hits is P(0)=exp(−ρΔm) and the probability of obtaining at least one database hit is

p_{match}≡1−P(0)≡1−e^{-ρΔm} (2)

Taking into account the form of P_{match} and the number of ways that k matches can be selected from K peaks, yields

$${P}_{K} ( k ) = \frac{K !}{( K - k ) ! k !} {{ⅇ}^{- ( K - k ) n / {n}^{*}} ( 1 - {ⅇ}^{- n / {n}^{*}} )}^{k} . \qquad ( 3 )$$

In Equation (3) we refer to

$${n}^{*} ≡ \frac{{m}_{max} - {m}_{min}}{Δ m} \qquad ( 4 )$$

as the critical proteome size. If Equation (3) is approximated by the standard normal approximation, then, in terms of the fraction of matched peaks, f≡k/K, we obtain

$${p}_{K} ( f ) ≅ \frac{1}{\sqrt{2 {πσ}_{f}^{2}}} exp ( - \frac{{( f - {f}_{o} )}^{2}}{2 {σ}_{f}^{2}} ) , \qquad ( 5 )$$

where

f₀≈−exp(−n/n*) (6)

is the expected fraction of matched peaks, and

$${σ}_{f} = \sqrt{\frac{exp ( - n / {n}^{*} ) ( 1 - exp ( - n / {n}^{*} ) )}{K}} \qquad ( 7 )$$

is the standard deviation of matched fraction. The normal approximation to the binomial distribution is generally good for Kp_{match}>5 when P_{match}≦0.5, and K(1−p_{match})>5 when P_{match}>0.5. The expression for f₀ justifies our previous assumption as n* being the critical proteome size, since f₀≈1 when n>>n*, and f₀≈n/n* when n<<n*. Accordingly, we refer to a proteome that satisfies n>>n* as a “dense” proteome and a proteome with n<<n* as a “sparse” proteome.

The model predicts the following: 1) for sparse proteomes, linear dependence of matched fraction as a function of proteome size, 2) for dense proteomes, saturation of matched fraction at 100%, and 3) transition from linear dependence to saturation at a proteome size that is inversely proportional to the matching tolerance, Am. These general features are easily derived from the theoretical form, but they can also be understood intuitively.

In particular, linear behavior of the matched fraction follows from considering a small number of proteins, randomly distributed throughout the mass range [mₘᵢₙ, mₘₐₓ]. The likelihood of at least one database hit is proportional to the number of proteins in [mₘᵢₙ, mₘₐₓ]. Saturation for dense proteomes occurs because in any Δm interval there is likely to be at least one protein, so that almost every peak is likely to have at least one database hit, i.e., the fraction of matched peaks is ˜1. The transition between linear and saturated behavior occurs at the transition between sparse and dense proteomes. We can arbitrarily take this point as the density at which, on average, the spacing between proteins is Δm. This corresponds to a critical proteome size of n*˜(mₘₐₓ−mₘᵢₙ)/Δm, which is inversely proportional to the matching tolerance.

I.c. The Empirical Distribution of False Matches

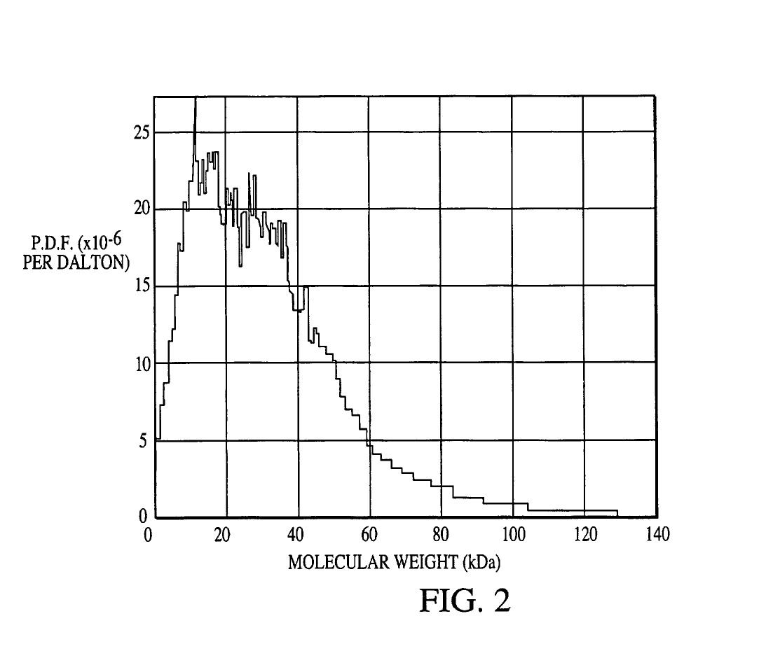

The previous section derives the distribution of false matches under the assumption that the underlying distribution of proteins was uniform. Since the underlying distribution of proteins is not uniform (c.f. FIG. 2), it is necessary to demonstrate that the derived distribution of false matches, reproduces the observed distribution. To do this, the first two moments (mean and standard deviation) of the empirical distribution are estimated, by performing simulated matching experiments, and then comparing the observed moments with those predicted by the theoretical distribution.

To perform the simulations, a subset of the SWISS-PROT proteome database (release 37) is used. At the present time, only a small fraction of the microorganisms represented in SWISS-PROT are fully sequenced. Moreover, most of the microorganisms (about 85%) are poorly characterized, in the sense that they have fewer than 10 proteins deposited in the database 10. The latter is eliminated from the database 10, since the distribution of the deposited proteins is likely to reflect the intellectual currents of scientific investigation, rather than being representative of any natural distribution.

The database 10 is further restricted to a mass range of 4000 to 20000 Da, since this is the mass range used in previously conducted experiments (Demirev et al.). This leaves a working database of 17652 proteins distributed among 219 microorganisms. Only three fields are preserved from the SWISS-PROT database in the working database: the protein mass (mass accuracy to 1 Da), the SWISS-PROT accession number, and the name of the microorganism

For each source microorganism, 3000 spectra in silico were simulated, by randomly selecting 15 proteins (without replacement) from its proteome. Each protein was equally likely to be chosen. To assure that each of these 3000 spectra is unique, the source microorganisms were restricted to the set of 58 microorganisms that contain 50 or more proteins. Each of these microorganisms has over 2×10¹² distinct 15-peak spectra. Consequently, it is extremely unlikely for a spectrum to appear more than once in the simulation.

Each simulated spectrum is compared against the proteomes of the remaining 218 microorganisms. For each source microorganism, there are 3000×218=6.5×10⁵ comparisons. Since there are 58 source microorganisms, the total number of spectrum-proteome comparisons is 3.8×10⁷. The software is implemented in portable ANSI-C and runs on either PowerPC or Pentium-based machines. It requires approximately ½ hour to perform all the simulations reported in this section using a Pentium-II Xeon 400 MHz processor.

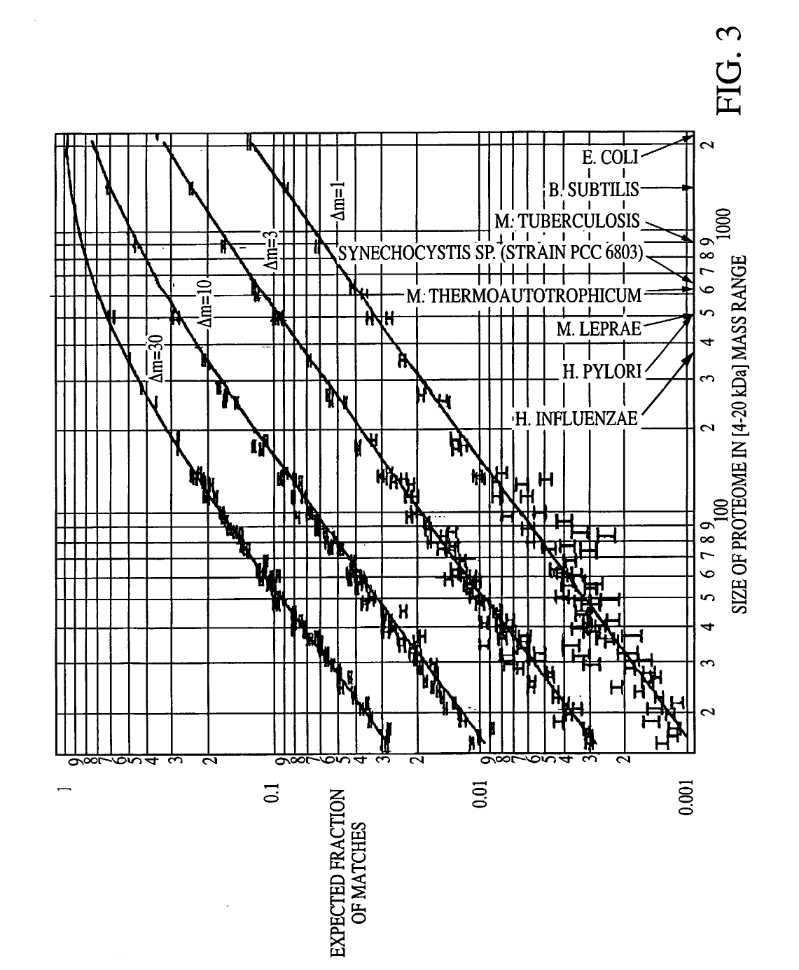

The theoretical distribution predicts that the expected fraction of false matches should depend simply on proteome size. Accordingly, a plot is made of the expected fraction of false matches obtained from the simulations, as a function of proteome size for Δm={1, 3, 10, 30} Da (FIG. 3). Simulated spectra were generated with exactly 15 peaks. The mass range was 4000-20000 Da. Proteome sizes for eight organisms in this mass range are marked. Solid lines are theoretical predictions. The data points are superimposed on the theoretically predicted curves. It is evident that there is excellent agreement between the simulation results and the theoretical prediction. The error bars in FIG. 3 are determined by the standard deviation of the empirically observed distribution and are proportional to the inverse square root of the number of random matching trials used to calculate the mean.

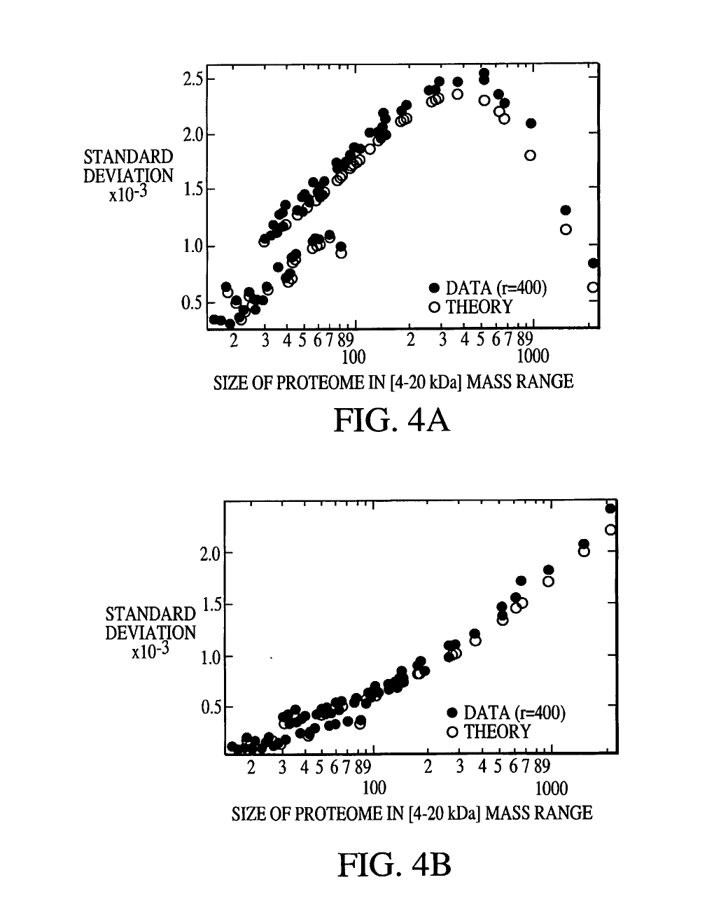

FIGS. 4A and 4B compare the observed and predicted error bars. Simulated spectra were generated with exactly 15 peaks. The mass range was 4000-20000 Da. For larger proteome sizes, a systematic deviation of approximately 10% is apparent at a resolution of m/Δm˜400 (FIG. 4A), whereas the agreement at m/Δm˜4000 is better (FIG. 4B). The discrepancy is attributed to the non-uniformity of the actual proteome distributions. This hypothesis was tested by repeating the simulation with an artificially generated database consisting of uniformly distributed proteomes. In this case, excellent agreement between the theory and the simulation data is observed.

To conclude, the theory presented herein agrees well with the simulation results despite the non-uniformity of the underlying proteome mass distributions. Except for a handful of proteomes, the protein mass distributions of individual microorganisms resemble the mass distribution of all bacterial proteins in SWISS-PROT (c.f. FIG. 2.). This distribution is far from uniform, especially in the 4000-20000 Da mass range. Moreover, since the model assumes a uniform mass distribution, one can overestimate the protein density near 4000 Da and underestimate it near 20000 Da. Intuitively, over estimates near 4000 Da tend to cancel underestimates near 20000 Da, leading to a value of P_{K}(k) that approximates the true distribution.

Strictly speaking, a large discrepancy between the actual protein distribution and the uniform distribution leads to systematic bias in expected values. For the problem at hand, these biases are small. But in the case of protein distributions that are peaked or have a wide dynamic range, e.g., the exponential mass distributions of tryptic peptides resulting from enzymatic protein digestions, these biases are not small and the empirical distribution of false matches is not well described by a model based on a uniform approximation.

II. Theory

II.a. Mass Accuracy and Proteome Density

The fact that microorganisms with dense proteomes have a high probability of matching all the peaks in an unknown spectrum implies that simple ranking algorithms are likely to fail when used with databases that contain such microorganisms. In particular, simple ranking algorithms will be biased towards incorrectly identifying an arbitrary spectrum as belonging to the microorganism with the densest proteome. Thus, to use simple ranking algorithms, it is necessary to use databases that exclude microorganisms with dense proteomes. This is problematic if excluded microorganisms are likely to be the sources of unknown mass spectrum. Increasing the sophistication of identification algorithms by taking into account complex physical processes, (e.g., posttranslational modifications, multiple charge states, adducts, etc.), can exacerbate the problem if including molecular species due to these processes effectively increases the size of the proteome beyond the critical proteome size.

The existence of a critical proteome density implies a lower limit on the mass accuracy that can be used with a simple ranking algorithm. In particular, suppose the densest proteome in the database 10 has nₘₐₓ proteins in the mass range [mₘᵢₙ, mₘₐₓ]. The requirement that dense proteomes be excluded from the database 10 implies that nₘₐₓ<n*, which in turn implies a relationship between the maximum proteome size and the mass accuracy,

$$Δ m < \frac{{m}_{max} - {m}_{min}}{{n}_{max}} . \qquad ( 8 )$$

For example, E. coli contains (in SWISS-PROT, release 37) by far the largest number of proteins (2124 against 1464 for currently the next largest microorganism proteome—that of B. subtilis) in the 4-20 kDa mass range. Accordingly, mass accuracy of ˜7.5 Da or better is needed for the mass spectral data to be useful for microorganism identification via a simple ranking algorithm. This corresponds to m/Δm˜2×10³ or mass resolution of ˜500 ppm. This relatively modest mass accuracy requirement enhances the prospects for small and inexpensive laboratory instruments for microorganism identification, since such mass accuracy may be achieved in the near future in field-portable instruments.

II.b. Significance Testing and Database Size

The inventive system, e.g., the processing module or another module, uses the derived probability distribution of false matches to test H₀ (the null hypothesis that the unknown and the known proteomes are not the same) by calculating the probability that the score exceeds the observed score, k_{obs},

$$α = P ( k \geq {k}_{obs} \vert {H}_{o} ) = {\sum }_{k = {k}_{c}}^{K} {P}_{K} ( k ) . \qquad ( 9 )$$

This sum can be evaluated exactly from Equation (3), or approximately in terms of the matched fractions from Equation (6). The test is performed with Δm=3 Da which, given the mass range 4-20 kDa, implies that n*=5333.3. This critical proteome size exceeds nₘₐₓ=2124 so there are no dense proteomes in our bacterial subset of SWISS-PROT. Moreover, the database 10 is restricted to fully sequenced microorganisms only. The calculated significance levels and the scores for the B. subtilis and E. coli MALDI mass spectra published previously (see Demirev et al.) are summarized in Table 1. In both cases the correct microorganism is identified as the source of the spectrum, based on significance level. In the case of E. coli, the null hypothesis was rejected at the α=0.311 significance level, while in the case of B. subtilis, the null hypothesis was rejected at the α=0.095 significance level.

Table 1. Matching scores and significance test results for two experimentally obtained MALDI mass spectra of intact organisms (see Demirev et al.).

| | | | |
|---|---|---|---|
| proteome | | significance | |
| size | score | level (a) | name |

B. subtilis (Δm = 3 Da), 14 spectral peaks

| | | | |
|---|---|---|---|
| 1464 | 6 | 0.095 | BACILLUS SUBTILIS. |
| 587 | 2 | 0.437 | BORRELLA BURGDORFERI. |
| 509 | 1 | 0.737 | HELICOBACTER PYLORI. |
| 2124 | 3 | 0.888 | ESCHERICHIA COLI. |

E. coli spectrum (Δm = 3 Da), 17 spectral peaks

| | | | |
|---|---|---|---|
| 2124 | 7 | 0.311 | ESCHERICHIA COLI. |
| 508 | 1 | 0.802 | HAEMOPHILUS INFLUENZAE. |
| 509 | 1 | 0.803 | HELICOBACTER PYLORI |
| 1464 | 3 | 0.813 | BACILLUS SUBTILIS |

These are not particularly significant rejections of the null hypothesis. Moreover, the significance values imply quite tight restrictions on the size of the database 10 that can be used for microorganism identification with the full proteome. For example, in the case of E. coli, had the database 10 contained three or more microorganisms whose proteome sizes were comparable to that of E. coli (2124 proteins), it would have been likely for at least one of these other microorganisms to have been accidentally achieved a score exceeding the E. coli score. This would have resulted in a misidentification. Similarly, a database containing 10 or more microorganisms with proteomes whose sizes were comparable to that of B. subtilis would be likely to yield a microorganism that would exceed the observed number of matches against the B. subtilis proteome.

Had the database 10 not been limited to fully sequenced microorganisms, the search would have turned up a large number of microorganisms with lower, yet more significant scores. One way to more firmly reject the null hypothesis, is to observe more matches. In particular, one would need scores of nine matches out of 14 peaks and 10 matches out of 14 peaks to yield significance levels better than 0.05 and 0.01, respectively. Another way of more firmly rejecting the null hypothesis is to decrease the proteome sizes by pruning out proteins that are unlikely to be observed. This would reduce the likelihood of false matches.

III. Discussion

The computed significance levels are sufficient to demonstrate the ability to identify microorganisms if the number of microorganisms under consideration is limited. It is clear, from the relatively modest significance levels that there is considerable room for improvement in both experimental and data processing techniques. In particular, the identification accuracy can be improved by maximizing true matches and minimizing false matches. True matches could be increased by: 1) improving measurement techniques so that more proteins are detected and 2) accounting for biochemical (e.g. posttranslational modifications) and measurement processes (e.g., multiple charge states adduct ions, etc.) that modify the molecular masses of the nominal proteomes. False matches could be reduced by: 1) increasing the mass-accuracy of the measurements, and 2) pruning the proteomes (e.g., excluding low abundance or unexpressed proteins) to reduce the protein density in the desired mass range. In a preferred embodiment, only ribosomal proteins are included in the proteome database 10.

As already pointed out, taking into account biochemical and measurement processes effectively increases the number of potential matches and thus increases the opportunity for false matches. In effect, it is equivalent to increasing the proteome size and must be done parsimoniously so as not to exceed the critical proteome size, n*. One must begin with a pruned proteome and then limit the number of biochemical and measurement processes that one includes in the model.

Finally, it is noted that to the extent that these complex processes introduce uncertainty in the observable mass of every protein in the proteome, they will have the effect of convolving the underlying distribution with a distribution whose width represents the range of biochemical and measurement uncertainties. The resulting smearing of the effective protein distribution will tend to make the effective protein distribution more uniform and thus the approximate theoretical distribution disclosed herein should become more accurate.

To conclude, the present invention quantifies the significance of microorganism identification by mass spectrometry-based proteome database searching through the use of a statistical model of false matches. The model is a useful tool for assessing the significance of identification scores and highlights areas where improvement is necessary in both experimental and data analysis techniques. Given the cluttered and incomplete nature of the data, it is likely that neither simple ranking, nor simple hypothesis testing will be sufficient for truly robust microorganism identification. Accordingly, in an effort to increase microorganism identification and to decrease the number of false matches, the proteomic database 10 is restricted to only include that more prevalent proteomes, such as ribosomal proteins.

What has been described herein is merely illustrative of the application of the principles of the present invention. For example, the functions described above and implemented as the best mode for operating the present invention are for illustration purposes only. Other arrangements and methods may be implemented by those skilled in the art without departing from the scope and spirit of this invention.

1. A system for determining a probability of observing false matches between spectral peaks of an unknown source and spectral peaks of known microorganisms, said system comprising:
a proteomic database for storing data of known microorganisms;
a processing module for determining the spectral peaks of known microorganisms using the proteomic database;
a scoring algorithm for comparing the spectral peaks of the unknown source with the spectral peaks as determined by the processing module for the known microorganisms, said scoring algorithm deriving a score for the unknown source based on the number of spectral peaks of the unknown source that match spectral peaks of known microorganisms; and
a probability module using at least the derived score and proteomes corresponding to the known microorganisms to determine the probability of observing false matches between the spectral peaks of the unknown source and the spectral peaks of the known microorganisms.

2. The system according to claim 1, wherein the data stored within the proteomic database includes proteomic and/or genetic data of the known microorganisms.

3. The system according to claim 1, wherein the probability module determines a probability distribution of false matches.

4. The system according to claim 1, wherein the proteins of the known microorganisms are uniformly distributed throughout a given mass range.

5. The system according to claim 4, wherein the given mass range is 4000 to 20000 Da.

6. The system according to claim 1, wherein the proteomic database excludes microorganisms with dense proteomes.

7. The system according to claim 1, wherein the processing module tests the null hypothesis that the unknown source is a known microorganism.

8. The system according to claim 1, wherein the proteomic database is restricted to fully sequenced microorganisms.

9. The system according to claim 1, wherein the proteomic database includes only ribosomal proteins.

10. A method for determining a probability of observing false matches between spectral peaks of an unknown source and spectral peaks of known microorganisms, said method comprising the steps of:
providing a proteomic database for storing data of known microorganisms;
determining the spectral peaks of known microorganisms using the proteomic database;
comparing the spectral peaks of the unknown source with the spectral peaks of the known microorganisms and deriving a score for the unknown source based on the number of spectral peaks of the unknown source that match spectral peaks of known microorganisms; and using at least the derived score and proteomes corresponding to the known microorganisms to determine the probability of observing false matches between the spectral peaks of the unknown source and the spectral peaks of the known microorganisms.

11. The method according to claim 10, wherein the step of using at least the derived score and proteomes corresponding to the known microorganisms determines a probability distribution of false matches.

12. The method according to claim 10, wherein further comprising the step of validating the determined probability using an empirical probability distribution.

13. The method according to claim 10, wherein the proteomic database includes proteins of the known microorganisms which are uniformly distributed throughout a given mass range.

14. The method according to claim 13, wherein the given mass range is 4000 to 20000 Da.

15. The method according to claim 10, further comprising the step of excluding microorganisms with dense proteomes from the proteomic database.

16. The method according to claim 10, further comprising the step of testing the null hypothesis that the unknown source is a known microorganism.

17. The method according to claim 10, further comprising the step of restricting the proteomic database to fully sequenced microorganisms.

18. The method according to claim 10, further comprising the step of including only ribosomal proteins in the proteomic database.

19. The method according to claim 10, further comprising the step of plotting an expected fraction of false matches obtained from simulations as a function of proteome size.

20. The method according to claim 10, wherein the step of step of using at least the derived score and proteomes corresponding to the known microorganisms further comprises the steps of:
determining a theoretical and an empirical probability distribution; and
comparing the theoretical and empirical probability distributions.

21. The method according to claim 10, further comprising the step of identifying the unknown source using the probability of observing false matches.
